(19) United States
(12) Patent Application Publication
(10) Pub. No.: US 2003/0081111 A1
(43) Pub. Date: May 1, 2003

(54) Method and system for videoconferencing

(76) Inventor: Michael Ledbetter, Richmond, CA (US)

Correspondence Address: Peter J. Shakula, Lee, Mann, Smith, McWilliams, Sweeney & Ohlson, P.O. Box 2786, Chicago, IL, 60690, US

(21) Appl. No.: 10/306,512

(22) Filed: Nov. 27, 2002

Related U.S. Application Data
(63) Continuation of application No. 09/864,912, filed on May 24, 2001.
Application No. 09/864,912 is a continuation-in-part of application No. 09/782,813, filed on Feb. 14, 2001.

(51) Int. Cl. H04N 7/14

(52) U.S. Cl. 348/14.08

(57) ABSTRACT

A method and system for videoconferencing over twisted pair wiring. The transmissions for the videoconference being of a broadcast quality. Input devices at each videoconference location receive a broadcast quality transmission and transmit the transmission to a modulator/demodulator which sends the transmission via twisted pair wiring to a video router where the transmission is routed to its proper destination. Output devices at each videoconference location receive a broadcast quality transmission over twisted pair wiring from a modulator demodulator which receives the transmission from the video audio router.

### CROSS-REFERENCE TO RELATED APPLICATIONS

This application is a continuation-in-part application Ser. No. 09/782,813, filed Feb. 14, 2001.

### BACKGROUND OF THE INVENTION

1. Field of the Invention

The present invention relates generally to the transmission of broadcast quality events, and more particularly, to a method and system for broadcast quality video-conferencing over a standard twisted pair copper wire.

2. Description of the Related Art

The current state of broadcast quality video and audio through both data networks and standard televisions is problematic. The main reason for this problem is a problem known in the industry as the “last mile” problem. This “last mile” problem is explained with reference to prior art FIG. 1.

Prior art FIG. 1 is a block diagram view of the current state of delivering broadcast quality content (for example, movies, news, sports, sitcoms, etc.) and stereophonic audio to an audience. In FIG. 1, captured content 5 is being sent to an audience 10 through the transmitter 15 and receiver 20. The captured content 5 can be any content such as movies, news, sports, commercials that is captured by a camera, audio receiver or the like. The captured content 5 is transmitted through a twisted pair 25 to the transmitter 15. The twisted pair 25 is a standard category 5 copper wire that is used in the paradigm of prior art FIG. 1. Cables can also be used to transmit the captured content 5 to the transmitter 15, as well as media twist copper lines. Generally, the twisted pair 25 is needed since the content is captured using a camera and the broadcast quality signal needs to be transmitted to audiences at their home. It is therefore imperative that the captured content 5 and quality of that captured content 5 remain at a broadcast quality level of appearance.

The broadcast quality level is typically determined by the pixel resolution of the image being viewed. Broadcast quality is known throughout the industry as a quality of at least 1,000 pixel by 1,000 pixels resolution. This is higher than the standard quality that audiences are used to viewing a captured content on a television (700 pixels by 800 pixels resolution). The general distance between the captured content 5 to the transmitter 15 is normally a few miles, such as the distance from an athletic stadium to a van or truck outside that will transmit the captured event inside the athletic stadium. The event is then transmitted from the transmitter 15 to the receiver 20. The transmitter 15 is generally a satellite held on a satellite truck outside of a athletic stadium, for example, using the previous example, and the receiver 20 is generally a cable distributor that receives the satellite signal of the captured content at the cable station. From the receiver, the captured content is sent to the audience 10 through a cable 30. Herein lies the problem addressed by the present invention. The distance from the receiver to the audience is typically known as the “last mile” problem discussed above. That is, in the past, the captured content arriving at the receiver 20 maintained the broadcast quality level of resolution of approximately 1,000 pixel by 1,000 pixels. However, to maintain that resolution to the audience 10, a cable line was needed or other means that maintained the quality of the captured content. Alternatives to the cable means was another satellite transmitter at the receiver 20 with a satellite receiver at the audience 10. Unfortunately, several problems exist with the cable 30 and satellite (not shown) alternatives to sending the captured content across the last mile 35.

A first problem is that cable lines are expensive to route from the receiver 20 to the audience 10. Likewise, satellite distribution of the captured content between the receiver 20 to the audience 10 requires equipment set up at the receiver 20 and audience 10 and costs are prohibitably high.

A further problem is that, in addition to broadcast quality content to a television, that same broadcast quality also needs to be sent to a computer, television or receiver through a data network. That is, the captured content 5 also may go through the cable 30 or satellite as long as sufficient broadband space is available on the cable or the satellite. In addition to cable and satellite-for data information, telephone companies are providing digital subscriber lines to the broadband signals to the audience 10 from the receiver 20. However, few consumers have taken advantage of the broadband advantages of DSL, cable modems and satellites because the quality of the captured content arriving on either the computer or television is not broadcast quality content. Thus, consumers who want broadband links have two choices: cable television companies which are about ⅔ of the way done with revamping the systems so that they can connect customers to the internet; and phone companies which are adding electronics to their switching centers to let them offer a high-speed service called digital subscriber lines. Satellite link ups are also becoming available but are trailing way behind.

Few people are taking advantage of this broadband capacity because customers are looking for an application that makes the broadband world touchable and believable to them, that shows its benefit. At present, the quality of the video content being sent over the internet has a poor resolution so consumers are not interested in purchasing the broadband services.

In essence, a severe problem exists in the industry in that the “last mile” 35 needs to be able to provide the captured content from the receiver 20 to the audience 10 at a broadcast quality level in order for consumers to watch the captured content on computers and televisions.

A need therefore exists for a manner of sending a broadcast quality content from the receiver 20 to the audience at a low cost to consumers and the industry as a whole. One method that would truly lower costs to all the telecommunications industry would be to provide the captured content 5 through a standard category 5 twisted pair copper wire that exists in virtually every office and home having a telephone. If it was possible to send a broadcast quality captured content from the receiver 20 through a category 5 copper wire to the audience 10 and maintain the broadcast quality of the signal low infrastructure costs and easy application could be performed by the telecommunications industry. However, under current conventional systems, a category 5 twisted pair copper wire is not capable of maintaining the broadcast quality from the receiver 20 to the audience 10 at the last mile.

One product known as the A/V Twister® sold by Prime Image, Inc. of San Jose, Calif. has attempted to solve a problem of sending a broadcast quality captured content 5 between the captured content 5 and a transmitter 15 through a category 5 copper wire 25. The A/V Twister® is a modulator/demodulator system 40 that is placed between the captured content 5 and a transmitter 15 in order to maintain the broadcast quality along the copper wire 25 between the captured content 5 and the transmitter 15. Typically, the modulator/demodulator system 40 is capable of maintaining a broadcast quality content for up to one mile on a standard category S copper wire or up to two miles on a media twist wire. As mentioned above, this modulator/demodulator system has only been used between the captured content 5 and the transmitter 15 but never between the receiver 20 and the audience 10.

A need therefore exists for a method of distributing the captured content between a receiver and an audience using a standard category 5 twisted pair wire.

### SUMMARY OF THE INVENTION

The present invention provides for a method of distributing an event to a viewer by capturing the event on a capturing device as a broadcast transmission. The broadcast transmission has at least a 1000 pixel by 1000 pixel resolution. The broadcast transmission is then transmitted to a distributing device where the broadcast transmission is distributed from the distributing device to a viewer over standard twisted pair wire at the 1000 pixel by 1000 pixel resolution.

The invention, in a further embodiment, provides for a method of distributing an event to a viewer by capturing the event on a capturing device as a broadcast transmission where the broadcast transmission has at least a frequency of 4.5 megahertz. The broadcast transmission is then transmitted to a distributing device and then the distributing device distributes the broadcast transmission to the viewer over standard twisted pair wire at a least a frequency of 4.5 megahertz.

In a still further embodiment, the present invention provides for a method of distributing a stereophonic event to a listener by capturing the stereophonic event on a capturing device into a stereophonic transmission, transmitting the stereophonic transmission to a distributing device and distributing the stereophonic transmission from the distributing device to the listener over a standard twisted pair wire.

In an even further embodiment, the present invention provides for a method of distributing a stereophonic and visual event to a viewer by capturing both the stereophonic and visual event on a capturing device into a stereophonic and broadcast transmission, where the stereophonic and broadcast transmission have at least a 1000 pixel by 1000 pixel resolution. Then the stereophonic and broadcast transmission is transmitted to a distributing device where both the stereophonic and broadcast transmission are distributed from the distributing device to the viewer over a standard twisted pair wire at the at least 1000 by 1000 pixel resolution.

In another embodiment, the present invention provides for a system for distributing an event to a viewer that includes a capturing device for capturing the event as a broadcast transmission where the broadcast transmission has at least a 1000 pixel by 1000 pixel resolution, a transmitting device for transmitting the broadcast transmission to a distributing device and a modulator/demodulator device between the distributing device and the viewer for distributing the broadcast transmission from the distributing device to the viewer over standard twisted pair wire at at least a 1000 pixel by 1000 pixel resolution.

The present invention further provides, in another embodiment, for a system for distributing an event to a viewer that includes a capturing device for capturing the event as a broadcast transmission where the broadcast transmission has at least a frequency of 4.5 megahertz, a transmitting device for transmitting the broadcast transmission to a distributing device, and a modulator/demodulator device between the distributing device and the viewer for distributing the broadcast transmission from the distributing device to the viewer over a standard twisted pair wire at a frequency of at least 4.5 megahertz.

In a further embodiment, the present invention provides for a system for distributing a stereophonic event to a listener including a capturing device for capturing the stereophonic event as a stereophonic transmission, a transmitting device for transmitting the stereophonic transmission to a distributing device and a modulator/demodulator device between the distributing device and the listener for distributing the stereophonic transmission from the distributing device to the listener over a standard twisted pair wire.

The invention further contemplates using a plurality of the distribution systems for video conferencing having broadcast quality transmissions, requiring only twisted pair wiring. By utilizing a video audio router, a videoconference may be held from a plurality of locations. Each location would require an input device. The input device would be connected to a distribution device. Similarly, each location requires an output device. The output device is connected to a second distribution device which can be at a separate location. By using a distribution device such as the aforementioned A/V Twister®. Each videoconferencing location is connected to the video router by twisted pair wiring up to five miles long. Furthermore, a plurality of additional output devices may be connected to the second distribution device by twisted pair wiring, each output device being a maximum distance of one mail from the adjacent device.

The method of videoconferencing utilizing the above system contemplates capturing a first broadcast event from a first party on a capturing device as a broadcast quality transmission. Transmitting the first broadcast quality transmission to a first distributing device. The first distributing device broadcasting the first broadcast quality transmission over a first twisted pair wiring to a router. The router then transmitting the the first broadcast quality transmission from the router to a second distribution device via a second pair of twisted pair wring. The second distribution device transmitting the first broadcast quality transmission to a second party.

Similarly, at the second party's location, a second capturing device captures a broadcast event as a second broadcast quality transmission. The second capturing device transmitting the second broadcast quality transmission to a third distribution device. The third distribution device transmitting the second broadcast quality transmission over the second pair of twisted pair wiring to the router. The router then transmitting the second broadcast quality transmission over the first pair of twisted pair wiring to a fourth distribution device. The fourth distribution device transmitting the second broadcast quality transmission to the first party.

As is the case with distributing an event, a broadcast quality transmission is understood to mean a transmission having at least a 1,000 pixel by 1,000 pixel resolution or a frequency of at least 4.5 megahertz.

### BRIEF DESCRIPTION OF THE DRAWINGS

A more complete appreciation of the invention and many of the advantages thereof will be readily obtained as the same becomes better understood by reference of the detailed description when considered in connection with the accompanying drawings, wherein:

Prior art FIG. 1 is a block diagram view of a conventional system for delivering broadcast quality content; and

FIG. 2 is a block diagram view of an embodiment of the system of the present invention;

FIG. 3 is a block diagram view of an embodiment of the system of the present invention that enables video-conferencing;

FIG. 4 is a block diagram view of the an embodiment of the system of the present invention that enables video-conferencing and has a plurality of additional receiver units for monitoring the video-conference.

### DETAILED DESCRIPTION OF THE PREFERRED EMBODIMENT

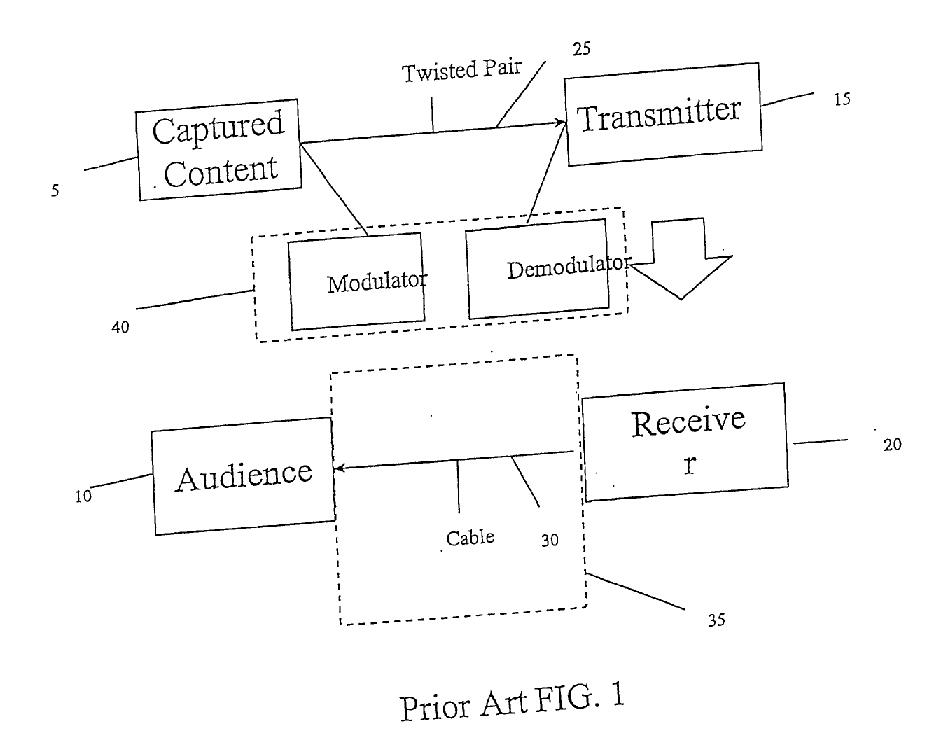

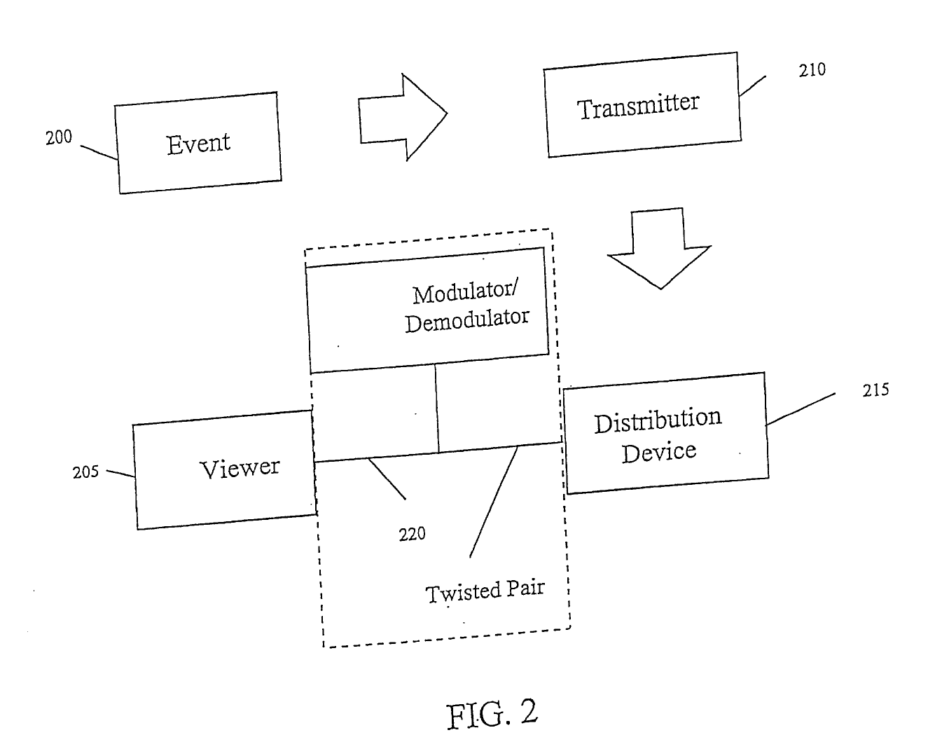

The present invention has a tremendous application to solve the problems related in the prior art relating to the “last mile” problem. Those benefits are apparent from FIG. 2 which is a block diagram view of an embodiment of the system of the present invention. In FIG. 2, an event 200 is to be transmitted to a viewer 205. The event may be any type of television content, for example, movies, news, sports, advertisements, or any other type of content that may be viewed by a viewer. The event may further be an audio event that may be listened to by a listener. Thus, the viewer 205, may be a listener (not shown) in a further embodiment of the present invention. Again, it is noted that the event, and content contained therein, be transmitted to the viewer as shown in FIG. 2. For example, in one embodiment, the event may be an athletic event, such as a football game, that is going to be transmitted to a viewer 205, to be viewed on a television (not shown) or computer monitor. The event is captured at 200, typically by broadcast quality camera, but may also be captured by any type of capturing device such as a recording device or other visual or audio recording means. The broadcast quality camera that captures the event 200 typically captures the event at a resolution of at least 1000 pixel by 1000 pixel. That is, as is well known in the broadcast art, the quality of the content being captured is broadcast quality, or of a resolution that is at least 1000 pixel by 1000 pixel as is well known in the art.

The event is typically conveyed to a transmitted 210 for further distribution. It is noted that the event is captured as a broadcast transmission, prior to sending the broadcast transmission to the transmitter 210. However, it is not necessary that the captured event be captured as a broadcast transmission at that point but only necessary that the event be somehow transmitted to the transmitter 210. After the event is transmitted to the transmitter 210, the transmitter transmits the broadcast transmission to a distributing device 215. It is noted that the captured event will broadcast transmission that is sent from the event 200 to the transmitter 210 and from the transmitter 210 to the distribution device 215 may be transmitted through various means. These means include transmitting the broadcast transmission over, for example, a satellite transmitter at the transmitter 210 that is received at the distribution device by satellite receiver. Other possible methods include transmitting the broadcast transmission over a cable line and receiving the broadcast transmission by a television receiver as the distribution device. Still further means includes transmitting the broadcast transmission over a media twist line and receiving the broadcast transmission by television receiver at the distribution device 215. By media twist, it is understood that this type of line is well known in the art and is manufactured by a company known as Belcore. Once the broadcast transmission arrives at the distribution device 215, the distribution device may then send the broadcast transmission to the viewer 205 through a standard twisted pair wire 220. Here is the true benefit of the present invention. By using a standard twisted pair wire 220, in conjunction with a modulator/demodulator 225, the broadcast transmission maintains it 1000 pixel by 1000 pixel resolution when it arrives at the viewer 205. In the past, a cable wire or satellite needed to be used in order to maintain that 1000 pixel by 1000 pixel resolution. This was expensive and burdensome to provide since cable lines needed to be connected to all viewers 205. However, twisted pair standard wire 220 is commonly used throughout all present locations such as homes and offices, as a standard telephone twisted pair wire. Thus, it is possible to easily use that infrastructure already set up in conjunction with the modulator/demodulator 225 to maintain the quality of the transmission for a distance of up to one mile using the standard twisted pair wire 220. Never before has a standard twisted pair wire 220 been capable of maintaining the 1000 pixel by 1000 pixel resolution at these distances. It is here that the true benefit of the invention is provided.

It is noted that the same benefits provided to a viewer 205 to receive at least a 1000 pixel by 1000 pixel resolution image is also available for stereophonic audio which was never before capable of being transmitted over a standard twisted pair wire in the past. Likewise, the combination of both the stereophonic transmission and the broadcast transmission simultaneously across the twisted pair wire 220 has also never been achieved. Thus, tremendous advantages and cost savings are achieved by using the modulator/demodulator 225 in conjunction with the standard twisted pair wire 220 to distribute both visual and stereophonic audio to a viewer and listener, respectively. It is noted that the modulator/demodulator may be a standard A/V Twister® that is manufactured by Prime Image, Inc. of San Jose, Calif., as described in the publication “A/V Twister, Twisted Pair Wire Carries the Load of Cable,” and printed in September 1998 by Prime Image, Inc. hereby incorporated by reference.

The method an system of the present invention has an endless number of applications. For example, any local area network utilizing personal computers may be connected over a standard twisted pair wire to deliver high resolution (1000 pixel by 1000 pixel) broadcast transmission to each work station. Again, as long as the modulator/demodulator is placed between the distribution device and the viewer, such standard copper twisted pair wire may be utilized. Another application would include networks for municipalities of a territory to communicate, on a scheduled basis, or in an emergency situation across live video feeds at the current 1000 pixel by 1000 pixel broadcast quality transmission. In this application, the event would be a recorded or captured event from a mayor's office, Chamber of Commerce, police department, or fire department which would be distributed, for example, through microwave or satellite communication to other municipality offices and distributed from that distribution device, such as the satellite, down to individual televisions or computer screens utilizing the twisted pair wires at a 1000 pixel by 1000 pixel resolution.

Still another application includes events in hotels, entertainment facilities or the like that could be transmitted between hotels at the 1000 by 1000 pixel resolution. Again, the applications are endless depending on the event which is to be transmitted to a viewer at the broadcast quality.

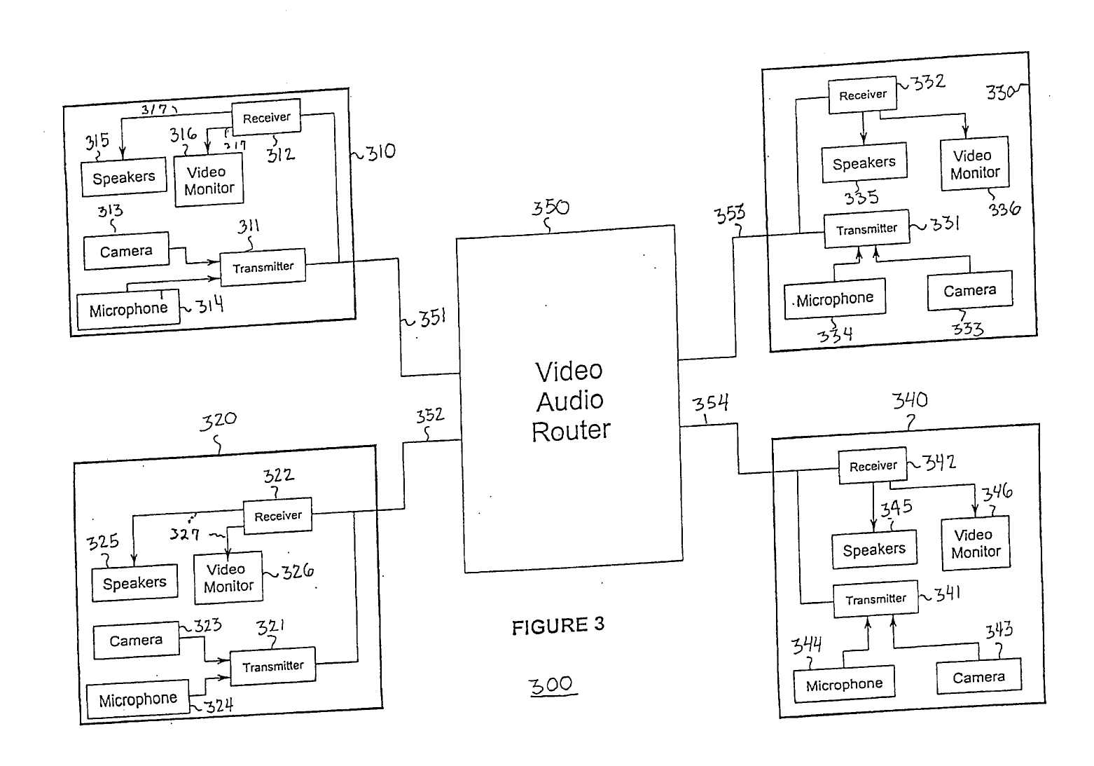

Another application of the method and system of this invention is videoconferencing. A system for videoconferencing is shown in FIG. 3 and generally denoted 300. White the system as shown in FIG. 3 shows four locations, 310, 320, 330 and 340 connected to a video router 350, this should not be construed as limiting. It is contemplated videoconferencing may occur between any two locations. Furthermore, the number of connections handled by the video audio router 350 are limited only by the capacity of the router itself.

Each location shows speakers and a video monitor connected to a receiver for receiving video and audio transmission from another location. Also, each location has a camera and microphone connected to a transmitter for transmitting video and audio data. It should be recognized that even though the speakers and video monitor are shown an separate blocks, these devices may be incorporated into a single apparatus. Similarly, the camera and microphone may be combined into one apparatus, and the transmitter and receiver may be a single apparatus. It should also be pointed out that the block diagrams for each location are functional, and do not necessarily indicate the spatial relationship between components. The video monitor, speakers, camera and microphone are required to be at a specific location in order for parties utilizing the system to interact with these devices, the transmitter and receiver do not necessarily have to be located spatially nearby. For example, if the receiver has a modulator/demodulator output capable of transmitting on twisted pair wiring, the receiver may be located several thousand feet away from the speakers and video monitor, connected by twisted pair wiring.

Referring to the first location 310, twisted pair wiring 351 connects location 310 to the video audio router 350. The twisted pair terminates into a transmitter 311 and a receiver 312. The transmitter 311, receiver 312 or both may be a distribution device such as a twisted pair audio and video transmission system like the aforementioned A/V Twister®, or a similar modulator/demodulator device. Speakers 315 and a Video Monitor 316 are connected to the receiver 312. The speakers 315 and video monitor 316 output a broadcast received from another location to the first location 310. A camera 313 and microphone 314 are connected to the transmitter 311 for capturing broadcast data from location 310.

Referring to the second location 320, twisted pair wiring 352 connects location 320 to the video audio router 350. The twisted pair terminates into a transmitter 321 and a receiver 322. As in the first location, the transmitter 321, receiver 322 or both may be a distribution device such as a twisted pair audio and video transmission system like the aforementioned A/V Twister®, or a similar modulator/demodulator device. Speakers 325 and a Video Monitor 326 are connected to the receiver 322. The speakers 325 and video monitor 326 output a broadcast received from another location to the second location 320. A camera 323 and microphone 324 are connected to the transmitter 321 for capturing broadcast data from location 320.

Similarly, twisted pair wiring 353 connects the third location 330 to the audio video router. The twisted pair terminates into a transmitter 331 and a receiver 332. As in the first location, the transmitter 331, receiver 332 or both may be a distribution device such as a twisted pair audio and video transmission system like the aforementioned A/V Twister®, or a similar modulator/demodulator device. Speakers 335 and a Video Monitor 336 are connected to the receiver 332. The speakers 335 and video monitor 336 output a broadcast received from another location to the third location 330. A camera 333 and microphone 334 are connected to the transmitter 331 for capturing broadcast data from location 330.

Likewise, twisted pair wiring 354 connects the fourth location 340 to the audio video router. The twisted pair terminates into a transmitter 341 and a receiver 342. As in the first location, the transmitter 341, receiver 342 or both may be a distribution device such as a twisted pair audio and video transmission system like the aforementioned A/V Twister®, or a similar modulator/demodulator device. Speakers 345 and a Video Monitor 346 are connected to the receiver 342. The speakers 345 and video monitor 346 output a broadcast received from another location to the fourth location 340. A camera 343 and microphone 344 are connected to the transmitter 341 for capturing broadcast data from location 340.

A method for using the aforementioned system for videoconferencing will now be explained. For purpose of illustration only, it will be assumed the videoconference is between a party at the first location 310 and the second location 320. However, the video conference can take place between any two locations. A user (not shown) at a first location 310 would use either the camera 313, microphone 314 or both to capture an event to be broadcast as a first broadcast quality transmission. The first broadcast quality transmission is transmitted to the transmitter 311. The transmitter having a modulator/demodulator transmits the first broadcast quality transmission on twisted pair wiring 351 to the video audio router 350. The video audio router then routes the first broadcast quality transmission to the correct destination. In the case of this example, the second location is location 320, therefore, the first broadcast quality transmission is sent from router 350 via twisted pair 352 to location 320 where it is received by receiver 322. Twisted pair wiring 327 transmits the broadcast quality signal from the receiver 322 to the video monitor 326 and speakers 325 for output to the second party (not shown).

The second party (not shown) at the second location 320 would use either the camera 323, microphone 324 or both to capture an event to be broadcast as a second broadcast quality transmission. The second broadcast quality transmission is transmitted to the transmitter 321. The transmitter having a modulator/demodulator transmits the second broadcast quality transmission on twisted pair wiring 352 to the video audio router 350. The video audio router then routes the second broadcast quality transmission to the correct destination. In the case of this example, the destination is the first location 310, therefore, the second broadcast quality transmission is sent from router 350 via twisted pair 351 to location 310 where it is received by receiver 312. Twisted pair wiring 317 transmits the broadcast quality signal from the receiver 312 to the video monitor 316 and speakers 315 for output to the first party (not shown).

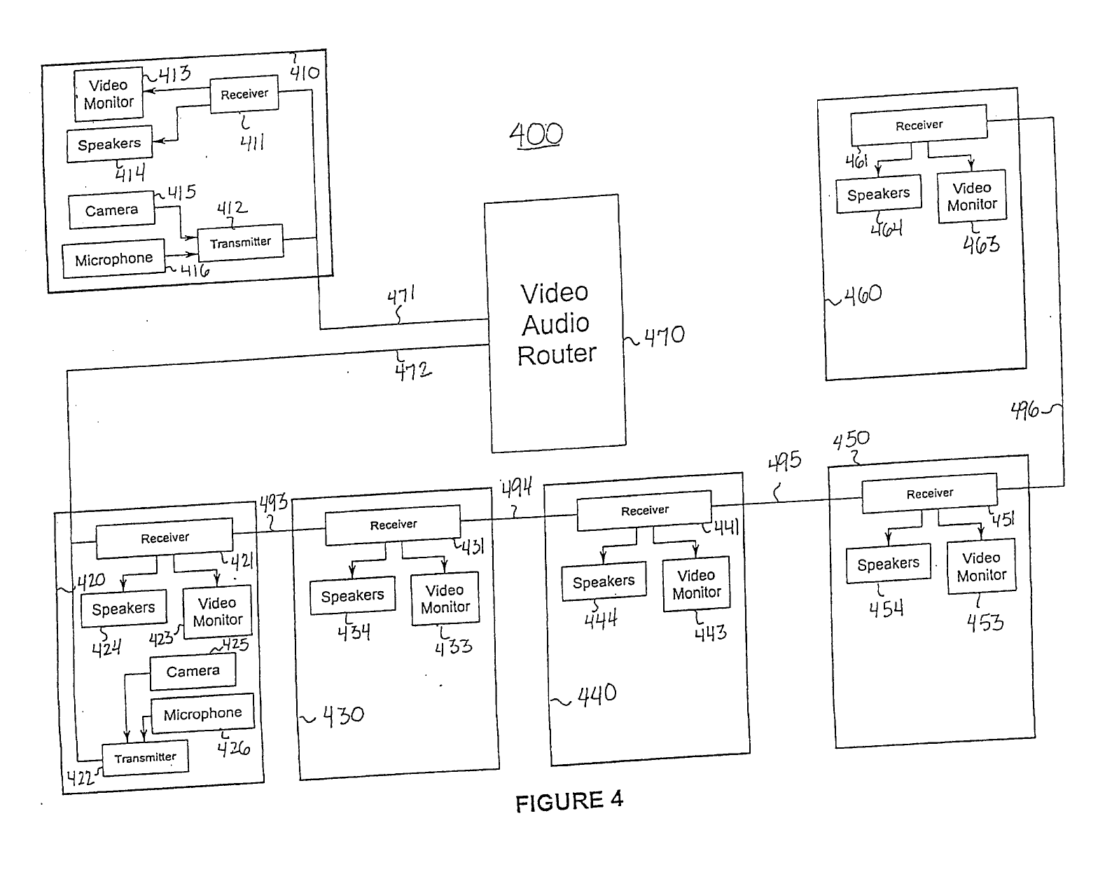

In addition to regular videoconferencing, it is envisioned that the system and method for videoconferencing has additional capabilities at each location for passive monitoring. This is illustrated in FIG. 4, where additional receiving stations at the second location are monitoring a broadcast from the first location.

Referring to the first location 410, twisted pair wiring 471 connects location 410 to the video audio router 470. The twisted pair terminates into a transmitter 412 and a receiver 411. The transmitter 412, receiver 411 or both may be a distribution device such as a twisted pair audio and video transmission system like the aforementioned A/V Twister®, or a similar modulator/demodulator device. Speakers 414 and a Video Monitor 413 are connected to the receiver 411. The speakers 414 and video monitor 413 output a broadcast received from another location to the first location 410. A camera 415 and microphone 416 are connected to the transmitter 412 for capturing broadcast data from location 410.

Referring to the second location 420, twisted pair wiring 472 connects location 420 to the video audio router 470. The twisted pair terminates into a transmitter 422 and a receiver 421. As in the first location, the transmitter 422, receiver 421 or both may be a distribution device such as a twisted pair audio and video transmission system like the aforementioned A/V Twister®, or a similar modulator/demodulator device. Speakers 424 and a Video Monitor 423 are connected to the receiver 421. The speakers 424 and video monitor 423 output a broadcast received from another location to the second location 420. A camera 425 and microphone 426 are connected to the transmitter 422 for capturing broadcast data from location 420.

Twisted pair wiring 493 connects location 420 to a third location 430. Location 430 only has receiving capabilities. Twisted wiring pair 493 is connected from an output of receiver 421 to an input of receiver 431. Receiver 431 provides a broadcast quality transmission to video monitor 433 and speakers 434.

Similarly, twisted pair wiring 494 connects location 430 to a fourth location 440. Location 440 also has only receiving capabilities. Twisted wiring pair 494 is connected from an output of receiver 431 to an input of receiver 441. Receiver 441 provides a broadcast quality transmission to video monitor 443 and speakers 444.

Similarly, twisted pair wiring 495 connects location 440 to a fifth location 450. Location 450 also has only receiving capabilities. Twisted wiring pair 495 is connected from an output of receiver 441 to an input of receiver 451. Receiver 451 provides a broadcast quality transmission to video monitor 453 and speakers 454.

Finally, twisted pair wiring 496 connects location 450 to a sixth location 460. Location 460 also has only receiving capabilities. Twisted wiring pair 496 is connected from an output of receiver 451 to an input of receiver 461 Receiver 461 provides a broadcast quality transmission to video monitor 463 and speakers 464.

By using modulators/demodulators for receivers 421, 431, 441, 451 and 461, twisted wire pairs 493, 494, 495 and 496 may be up to one mile long and still provide broadcast qualtiy. This method may be useful for virtual classrooms, or governmental functions such as broadcasting local government meetings or courthouse arraignments.

A method for using the aforementioned system for videoconferencing will now be explained. For purpose of illustration only, it will be assumed the videoconference is between a party at the first location 410 and the second location 420. However, the video conference can take place between any two locations. A user (not shown) at a first location 410 would use either the camera 415, microphone 416 or both to capture an event to be broadcast as a first broadcast quality transmission. The first broadcast quality transmission is transmitted to the transmitter 412. The transmitter 412 having a modulator/demodulator transmits the first broadcast quality transmission on twisted pair wiring 471 to the video audio router 470. The video audio router then routes the first broadcast quality transmission to the correct destination which in this case the second location is location 420, therefore, the first broadcast quality transmission is sent from router 450 via twisted pair 472 to location 420 where it is received by receiver 421. Twisted pair wiring transmits the broadcast quality signal from the receiver 421 to the video monitor 413 and speakers 414 for output to the second party (not shown).

The second party (not shown) at the second location 420 would use either the camera 425, microphone 426 or both to capture an event to be broadcast as a second broadcast quality transmission. The second broadcast quality transmission is transmitted to the transmitter 422. The transmitter 422 having a modulator/demodulator transmits the second broadcast quality transmission on twisted pair wiring 472 to the video audio router 470. The video audio router then routes the second broadcast quality transmission to the correct destination, which in this case is the first location 410. Therefore, the second broadcast quality transmission is sent from router 470 via twisted pair 471 to location 410 where it is received by receiver 411. The receiver 411 transmits the broadcast quality transmission over twisted pair wiring to the video monitor 413 and speakers 414 for output to the first party (not shown).

The first broadcast quality transmission is also received at locations 430, 440, 450 and 460. Twisted pair wiring 493 connects receiver 421 at location 420 to receiver 431 at location 430. The first broadcast quality transmission is then received by video monitor 433 and speakers 434 for output from receiver 431. Similarly, twisted pair wiring 494 connects receiver 431 at location 430 to receiver 441 at location 440. The first broadcast quality transmission is then received by video monitor 443 and speakers 444 for output from receiver 441. In a like manner twisted pair wiring 495 connects receiver 441 at location 440 to receiver 451 at location 450. The first broadcast quality transmission is then received by video monitor 453 and speakers 454 for output from receiver 451. Finally, twisted pair wiring 496 connects receiver 451 at location 450 to receiver 461 at location 460. The first broadcast quality transmission is then received by video monitor 463 and speakers 464 for output from receiver 461.

While FIG. 4 shows the additional receivers only at the second location, it should be noted that this configuration for adding additional speakers to a location can be used at any of the videoconferencing locations. For example in FIG. 3, the additional receivers can be added to either receiver 312 at location 310, receiver 322 at location 320, receiver 332 at location 330, receiver 342 at location 440, or to any combination of these receivers.

Although the invention has been shown and described with respect to a certain preferred embodiment, it is obvious that equivalent alterations and modifications will occur to others skilled in the art upon the reading and understanding of this specification. The present invention includes all such equivalent alterations and modifications and is limited only by the scope of the following claims.

What is claimed is:

1. A method for videoconferencing, comprising:
capturing a first broadcast event from a first party on a capturing device as a broadcast quality transmission;
transmitting said first broadcast quality transmission to a first distributing device;
transmitting said first broadcast quality transmission from said distributing device to a routing device over a first standard twisted pair wire;
transmitting said first broadcast quality transmission from said routing device to a second distributing device over a second standard twisted pair wire;
distributing said first broadcast quality transmission from said second distributing device to a second party;
capturing a second broadcast event from said second party on a second capturing device as a broadcast quality transmission;
transmitting said second broadcast quality transmission to a third distributing device;
transmitting said second broadcast quality transmission from said third distributing device to a routing device over said second standard twisted pair wire;
transmitting said second broadcast quality transmission from said routing device to a fourth distributing device over said first standard;
distributing said second broadcast quality transmission from said fourth distributing device to said first party.

2. The method of claim 1, wherein said first broadcast quality transmission comprising at least a 1,000 pixel by 1,000 pixel resolution and said second broadcast quality transmission comprising at least a 1,000 pixel by 1,000 pixel resolution.

3. The method of claim 1, wherein said first broadcast quality transmission having at least a frequency of 4.5 megahertz and said second broadcast quality transmission at least a frequency of 4.5 megahertz.

4. The method of claim 1, wherein said capturing a first broadcast event step further comprises the step of capturing said event on a broadcast quality camera, and said capturing a second broadcast event step further comprises the step of capturing said event on a broadcast quality camera.

5. The method of claim 1, wherein said transmitting said first broadcast transmission from said second distributing device to a second party step further comprises the steps of:
transmitting said first broadcast quality transmission over a media twist line; and
receiving said first broadcast quality transmission by a television receiver.

6. The method of claim 5, wherein said transmitting said second broadcast transmission from said fourth distributing device to said first party step further comprises the steps of:
transmitting said second broadcast quality transmission over a media twist line; and
receiving said second broadcast quality transmission by a second television receiver.

7. The method of claim 1, wherein said first twisted pair wire is a copper wire and said second twisted pair is a copper wire.

8. The method of claim 7, wherein said first standard twisted pair is a category five copper wire, and said second standard twisted pair is a category five copper wire.

9. The method of claim 8, wherein the distributing said first broadcast quality transmission step further comprises distributing said first broadcast quality transmission from said second distributing device to said second party over said standard twisted pair wire for a distance of up to one mile.

10. The method of claim 9, where the distributing said second broadcast quality transmission step further comprises distributing said broadcast quality transmission from said second distributing device to said second party over said standard twisted pair wire for a distance of up to one mile.

11. The method of claim 1, wherein said first standard twisted pair is a media twist line, and said second twisted pair is a media twist line.

12. The method of claim 11, wherein the distributing said first broadcast quality transmission step further comprises distributing said first broadcast quality transmission from said second distributing device to said second party over said media twist line for a distance of up to two miles.

13. The method of claim 12, where the distributing said second broadcast quality transmission step further comprises distributing said broadcast quality transmission from said second distributing device to said second party over said media twist line for a distance of up to two miles.

14. The method of claim 1, wherein:
said first distributing device is a modulator/demodulator;
said second distributing device is a modulator/demodulator;
said third distributing device is a modulator/demodulator, and
said fourth distributing device is a modulator/demodulator.

15. The method of claim 1, wherein
said first broadcast event comprises a first video event and first stereophonic event;
said second broadcast event comprises a second video event and a second stereophonic vent.

16. The method of claim 15, wherein said first broadcast quality transmission comprising at least a 1,000 pixel by 1,000 pixel resolution and said second broadcast quality transmission comprising at least a 1,000 pixel by 1,000 pixel resolution.

17. The method of claim 15, wherein said first broadcast quality transmission having at least a frequency of 4.5 megahertz and said second broadcast quality transmission at least a frequency of 4.5 megahertz.

18. A system for videoconferencing comprising:
a first capturing device for capturing a first event as a first broadcast quality transmission;
a first distribution device coupled to said first capturing device;
a routing device;
a first twisted pair wiring connecting said first distribution device to said routine device;
a second distribution device connected to said routing device by a second twisted pair wiring;
a first output device connected to said second distribution device by a third twisted pair wiring;
a second capturing device for capturing a second event as a second broadcast quality transmission;
a third distribution device coupled to said second capturing device, said third distribution device connected to said routing device by said second twisted pair wiring;
a fourth distribution device coupled to said routing device by said first twisted pair wiring;
a second output device connected to said fourth distribution device by a fourth twisted pair wiring.

19. A system for videoconferencing, comprising:
a first input means;
a first modulator/demodulator receiving connected to said input means;
a video router connected to said first modulator/demodulator by a first twisted pair wiring;
a first output means being connected to said first modulator/demodulator;
a second modulator/demodulator connected by a second twisted pair wiring to said video router;
a second output means connected to said second modulator/demodulator;
a second input means connected to said modulator/demodulator.

20. The system of claim 19, further comprising:
a third modulator/demodulator connected by a third twisted pair wiring to said second modulator/demodulator;
a third output means connected to said third modulator/demodulator.

21. The system of claim 20, further comprising:
a fourth modulator/demodulator connected by a fourth twisted pair wiring to said third modulator/demodulator;
a fourth output means connected to said third modulator/demodulator.

22. The system of claim 21, further comprising:
a fifth modulator/demodulator connected by a fifth twisted pair wiring to said fourth modulator/demodulator;
a fifth output means connected to said third modulator/demodulator.

22. The system of claim 21, further comprising:
a sixth modulator/demodulator connected by a sixth twisted pair wiring to said fifth modulator/demodulator;
a sixth output means connected to said third modulator/demodulator.
